(19) United States
(12) Patent Application Publication
(10) Pub. No.: US 2026/0261932 A1
(43) Pub. Date: Sep. 3, 2026

(54) METHOD FOR TRANSMITTING CONFIGURATION INFORMATION AND COMMUNICATION APPARATUS

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/881,886

(22) PCT Filed: Jul. 12, 2022
(86) PCT No.: PCT/CN2022/105277

§ 371 Date: Jan. 7, 2025

(51) Int. Cl. H04W 36/08; H04W 52/02

(52) U.S. Cl. CPC H04W 36/08; H04W 52/0206

(57) ABSTRACT

The present disclosure provides a method and apparatus for transmitting configuration information, and a readable storage medium. The method comprises: receiving configuration information sent by a first network device corresponding to a first primary cell, wherein the configuration information is used for indicating that a first secondary cell in at least one secondary cell is configured as a second primary cell, and a serving cell of user equipment comprises the first primary cell and the at least one secondary cell.

### CROSS-REFERENCE TO RELATED APPLICATIONS

The present application is a U.S. National Stage of International Application No. PCT/CN 2022/105277, filed on Jul. 12, 2022, the entire content of which is incorporated herein by reference for all purposes.

### TECHNICAL FIELD

The present disclosure relates to a field of wireless communication technology, and more particularly to a method and an apparatus for transmitting configuration information and a non-transitory readable storage medium.

### BACKGROUND

In Release 18 (R18) of the 3rd Generation Partnership Project (3GPP), cell on-off may be dynamically performed to save energy consumption of a network device. When the cell has few or no service, the cell may be closed to save energy consumption, and the cell may be reactive upon receiving a wake-up indication from the user equipment (UE) or other network nodes. When the cell is in an off state, the cell may be in a light sleep state (shallow sleep state), thus allowing for rapid transitions between sleep and wake-up states.

Before the cell is dynamically turned off for energy saving, the connected the user device in the cell needs to perform a handover process (handover process) to switch to a new cell.

Addressing the excessive overhead incurred by the user device during the handover process is critical.

### SUMMARY

The present disclosure provides a method and an apparatus for transmitting configuration information and a non-transitory readable storage medium.

In a first aspect, the present disclosure provides a method for receiving configuration information, performed by a user device, including:
receiving configuration information sent by a first network device corresponding to a first primary cell, where the configuration information is configured to indicate to configure a first secondary cell in at least one secondary cell as a second primary cell, and a serving cell of the user device includes the first primary cell and the at least one secondary cell.

In a second aspect, the present disclosure provides a method for sending configuration information, performed by a first network device, including:
sending configuration information to a user device, where the configuration information is configured to indicate to configure a first secondary cell in at least one secondary cell as a second primary cell, and a serving cell of the user device includes a first primary cell and the at least one secondary cell.

In a third aspect, the present disclosure provides a method for sending configuration information, performed by a second network device, including:
sending third auxiliary information to a first network device, where the third auxiliary information is configured to indicate whether a secondary cell corresponding to the second network device meets a setting condition for being a primary cell.

In a third aspect, the present disclosure provides a communication apparatus including a processor and a memory, where the memory is configured to store computer programs; and the processor is configured to execute the computer program to implement the first aspect or any possible design of the first aspect.

In a fourth aspect, the present disclosure provides a communication apparatus including a processor and a memory, where the memory is configured to store computer programs; the processor is configured to execute the computer program to implement the second aspect or any possible design of the second aspect.

In a fifth aspect, the present disclosure provides a communication apparatus including a processor and a memory, where the memory is configured to store computer programs; the processor is configured to execute the computer program to implement the third aspect or any possible design of the third aspect.

It should be understood that the above general description and the following detailed descriptions are illustrative and explanatory only and are not used to limit embodiments of the present disclosure.

### BRIEF DESCRIPTION OF THE DRAWINGS

The accompanying drawings illustrated herein are used to provide a further understanding of the embodiments of the present disclosure and constitute a part of the application, and the schematic embodiments of the present disclosure and illustrations thereof are used to explain the embodiments of the present disclosure and do not constitute an undue limitation of the embodiments of the present disclosure, in which:

The accompanying drawings, which are incorporated in and constitute a part of this specification, illustrate embodiments consistent with the present disclosure and, together with the description, serve to explain the principles of the embodiments of the present disclosure.

FIG. 1 is a schematic diagram of a wireless communication system architecture provided in an embodiment of the present disclosure;

FIG. 2 is a flowchart of a method for transmitting configuration information according to an embodiment;

FIG. 3 is a flowchart of another method for transmitting configuration information according to an embodiment;

FIG. 4 is a flowchart of another method for transmitting configuration information according to an embodiment;

FIG. 5 is a flowchart of another method for transmitting configuration information according to an embodiment;

FIG. 6 is a flowchart of a method for receiving configuration information according to an embodiment;

FIG. 7 is a flowchart of another method for receiving configuration information according to an embodiment;

FIG. 8 is a flowchart of another method for receiving configuration information according to an embodiment;

FIG. 9 is a flowchart of a method for sending configuration information according to an embodiment;

FIG. 10 is a flowchart of another method for sending configuration information according to an embodiment;

FIG. 11 is a flowchart of another method for sending configuration information according to an embodiment;

FIG. 12 is a flowchart of another method for sending configuration information according to an embodiment;

FIG. 13 is a flowchart of a method for sending configuration information according to another embodiment;

FIG. 14 is a block diagram of an apparatus for receiving configuration information according to an embodiment;

FIG. 15 is a block diagram of the user device according to an embodiment;

FIG. 16 is a block diagram of an apparatus for sending configuration information according to an embodiment;

FIG. 17 is a block diagram of a communication apparatus according to an embodiment;

FIG. 18 is a block diagram of an apparatus for sending configuration information according to an embodiment.

### DETAILED DESCRIPTION

Embodiments of the present disclosure are now further described with reference to the accompanying drawings and embodiments.

Reference will now be made in detail to some embodiments of the present disclosure, examples of which are illustrated in the accompanying drawings. The following descriptions refer to the accompanying drawings in which the same numbers in different drawings represent the same or similar elements unless otherwise represented. The embodiments set forth in the following descriptions of some embodiments do not represent all embodiments consistent with embodiments of the present disclosure. Instead, they are merely examples of apparatuses and methods consistent with aspects related to the embodiments of the present disclosure as recited in the appended claims.

The terms used in the embodiments of the present disclosure are only for the purpose of describing specific embodiments and are not intended to limit the embodiments of the present disclosure. The singular forms of “a” and “the” used in the embodiments of the present disclosure and appended claims are also intended to include plural forms, unless the context clearly indicates other meanings. It should also be understood that the term “and/or” as used herein refers to and includes any or all possible combinations of one or more associated listed items.

It should be understood that although the terms first, second, and third may be used in the embodiments of the present disclosure to describe various information, the information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when”, “while” or “in response to determining”.

The embodiments of the present disclosure are described in detail below. Examples of the embodiments are illustrated in the accompanying drawings where the same or similar numbers throughout indicate the same or similar elements. The embodiments described below by reference to the accompanying drawings are illustrative and are intended to interpret the present disclosure and are not to be construed as a limitation of the present disclosure.

As shown in FIG. 1, the method for transmitting configuration information provided according to embodiments of the present disclosure may be applied to a wireless communication system 100. The wireless communication system may include the user device 101, a first network device 102 and a second network device 103, where the user device 101 is configured to support carrier aggregation and may be connected to a plurality of carrier units of the first network device 102 or the second network device 103, which includes a main carrier unit and one or more secondary carrier units.

The user device 101 may configure a plurality of cells as serving cells, and the serving cell includes one primary cell (Pcell) and one or more secondary cells (Scell). The first network device 102 corresponds to the primary cell of the user device 101, and the second network device 103 corresponds to the secondary cell of the user device 101.

It should be understood that the above wireless communication system 100 may be suitable for both low-frequency scenes and high-frequency scenes. An application scene of the wireless communication system 100 includes, but is not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, or a future evolved public land mobile network (PLMN) system, etc.

The user device 101 (UE) shown above may be a terminal, an access terminal, a terminal unit, a terminal station, a mobile station (MS), a remote station, a remote terminal, a mobile terminal, a wireless communication device, a terminal agent, or a terminal device, etc. The user device 101 may have a wireless transceiving function, and may be capable of perform communication (such as wireless communication) with one or more network devices of one or more communication systems and receiving a network service provided by the network device. The network device here includes, but is not limited to, the illustrated the first network device 102 or the second network device 103.

The user device 101 may be a cellular phone, a cordless telephone, a session initiation protocol (SIP) phone, a wireless local loop (WLL) station, a personal digital assistant (PDA) device, a handheld device having a wireless communication function, a computing device or another processing device connected to a wireless modem, a vehicle-mounted device, a wearable device, a terminal device in a future 5G network, or a terminal device in a future evolved PLMN network, etc.

The first network device 102 or the second network device 103 may be an access network device (or referred to as an access network station). Among them, the access network device refers to a device that provides a network access function, such as a radio access network (RAN) base station, etc. The network device 102 may specifically include a base station (BS), or may include a base station and a radio resource management device for controlling the base station, etc. The network device 102 may further include a relay station (a relay device), an access point, a base station in a future 5G network, a base station in a future evolved PLMN network or an NR base station, etc. The network device 102 may be a wearable device or a vehicle-mounted device. The network device 102 may also be a communication chip having a communication module.

For example, the first network device 102 or the second network device 103 includes, but is not limited to: a gnodeB (gNB) in 5G system, an evolved node B (eNB) in a LTE system, a radio network controller (RNC), a node B (NB) in a WCDMA system, a radio controller in a CRAN system, a base station controller (BSC), a base transceiver station (BTS) in a GSM system or a CDMA system, a home base station (such as a home evolved nodeB, or a home node B (HNB)), a baseband Unit (BBU), a transmitting and receiving Point (TRP), a transmitting point (TP), or mobile switching center, etc.

In scenarios where the primary cell (Pcell) corresponding to the user device 101 dynamically performs dynamic cell on-off switching to achieve energy saving, the user device under the primary cell needs to switch to a new cell through a handover process before the primary cell is closed. However, the handover process incurs significant overhead. For example, in the simplest case of non-contention-based access handover manner, the user device 101 needs to first initiate random access on an allocated Physical Random Access Channel (PRACH) resources, and then detect a Random Access Response (RAR), the RAR contains various pieces of information related to the new cell access. If the contention-based access handover manner is adopted, the overhead becomes even higher. Thus, it is crucial to address the excessive network and UE overhead caused by the handover process in such scenarios.

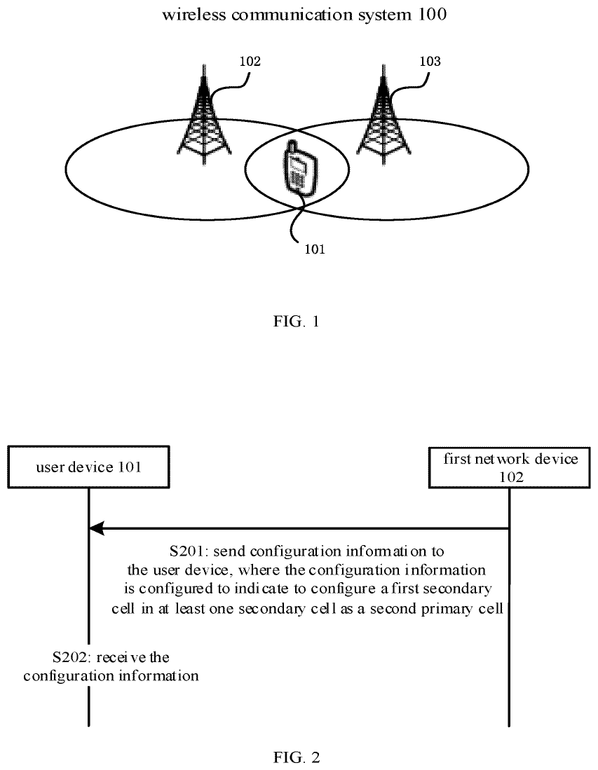

In an embodiment of the present disclosure, a method for transmitting configuration information is provided, referring to FIG. 2. FIG. 2 is a method for transmitting configuration information according to an embodiment, as shown in FIG. 2. The method includes steps S201-S202, specifically:
in step S201, a first network device 102 sends configuration information to the user device 101, the configuration information is configured to indicate to configure a first secondary cell in at least one secondary cell as a second primary cell, and a serving cell of the user device 101 includes the first primary cell and the at least one secondary cell.
in step S202, the user device 101 receives the configuration information sent by the first network device 102 corresponding to a first primary cell.

In some possible embodiments, the embodiment of the present disclosure is applied to a scenario where the first primary cell is dynamically turned off due to energy conservation, and step S201 is executed before the first primary cell is turned off, i.e., before the first primary cell enters the sleep state.

In some possible embodiments, the user device 101 may configure a plurality of cells as the servicing cells, and the servicing cell includes one primary cell (Pcell) and one or more secondary cells (Scell). The user device 101 uses the same Cell Radio Network Temporary Identifier (C-RNTI) in both the primary cell and the plurality of secondary cells.

The plurality of cells serving as the serving cells have been connected to the user device 101, and the user device 101 has acquired uplink and downlink synchronization of each cell in various serving cell.

In some possible embodiments, the first primary cell is used to refer to an original primary cell of the user device 101, which is a dynamically-closed primary cell; the network device corresponding to the first primary cell is referred to as the first network device 102. The second primary cell is used to refer to a new primary cell configured for the user device 101 by the first network device 102 corresponding to the original primary cell. The first network device 102 determines the first secondary cell from at least one secondary cell of the serving cells and configures the first secondary cell as the second primary cell. The network device corresponding to each secondary cell is referred to as the second network device 103.

In some possible embodiments, the configuration information may include an instruction to configure the first secondary cell as the new primary cell, and resource configuration for the first secondary cell, such as broadcast message configuration, PRACH configuration, mobility measurement configuration, etc,. Thus, the user device 101 may configure a new primary cell such that the user device may transmit services in the second primary cell when the first primary cell is closed.

In an example, the configuration information carries an identifier of the first secondary cell.

In an embodiment of the present disclosure, the first network device 102 may send configuration information to the user device 101 to configure the first secondary cell in the serving cell as the second primary cell. Thus, when the first primary cell is closed, the first secondary cell that has already established a connection with the user device 101 may be configured as a new primary cell, reducing unnecessary handover processes for the user device 101 and effectively reducing the overhead of the user device 101.

Moreover, in an embodiment of the present disclosure, when the configuration information includes the resource configuration of the first secondary cell, the user device 101 may acquire the resource configuration information of the second primary cell before switching to the second primary cell, thereby reducing the signaling interaction after switching and further saving the time overhead for the user device 101 to acquire the resource configuration of the second primary cell.

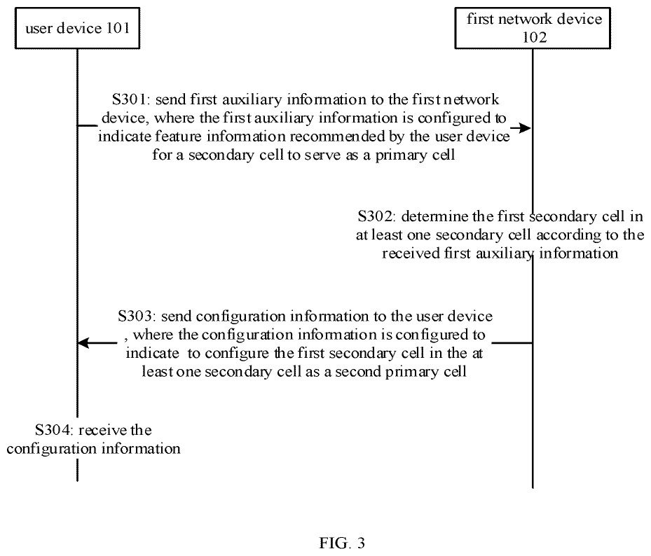

An embodiment of the present disclosure provides a method for transmitting configuration information, referring to FIG. 3. FIG. 3 is a method for transmitting configuration information according to an embodiment, as shown in FIG. 3. The method includes steps S301 to S304, specifically:
in step S301, the user device 101 sends first auxiliary information to the first network device 102, the first auxiliary information is configured to indicate feature information recommended by the user device for a secondary cell to serve as a primary cell.
in step 302, the first network device 102 determines the first secondary cell in at least one secondary cell according to the received first auxiliary information.
in step S303, the first network device 102 sends configuration information to the user device 101, the configuration information is configured to indicate to configure the first secondary cell in the at least one secondary cell as a second primary cell, and the servicing cell of the user device 101 includes a first primary cell and the at least one secondary cell.
in step S304, the user device 101 receives the configuration information sent by the first network device 102.

In some possible embodiments, the user device 101 may recommend to the first network device 102 a frequency band or identification information of the secondary cell that may serve as the primary cell.

In some possible embodiments, the first network device 102 may refer to the first auxiliary information reported by the user device 101 to determine a more suitable first secondary cell as a new primary cell, i.e., the second primary cell.

In an example, the first auxiliary information reported by the user device 101 indicates an operating frequency band in which the secondary cell recommended by the user device 101 as the primary cell operates to be band 1. The first network device 102 determines, according to the first auxiliary information, the secondary cells in band 1 in the servicing cells of the user device as Scell 1 and Scell 2, respectively.

In this example, the first network device 102 may determine the first secondary cell combined with the load situation of Scell 1 and Scell 2. For example, if the load of Scell 1 is greater than the load of Scell 2, Scell 1 serves as both the secondary cell for the user device 101 and the primary cell for other the user devices. The first network device 102 may determine Scell 2 with lower load as the first secondary cell and configure Scell 2 as the new primary cell.

In some possible embodiments, the configuration information may not only include an instruction to configure the first secondary cell as the new primary cell; it may also include resource configuration for the first secondary cell, such as broadcast message configuration, PRACH configuration, mobility measurement configuration, etc,.

In an example, the configuration information carries an identifier of the first secondary cell.

In an embodiment of the present disclosure, the user device 101 recommends to the first network device 102 feature information that may be served as the primary cell by reporting the first auxiliary information to the first network device 102. Thus, the first network device 102 may refer to the first auxiliary information, which is beneficial for determining a more suitable first secondary cell as the new primary cell, i.e., the second primary cell.

Moreover, in an embodiment of the present disclosure, when the configuration information includes the resource configuration of the first secondary cell, the user device 101 may acquire the resource configuration information of the second primary cell before switching to the second primary cell, thereby reducing the signaling interaction after switching and further saving the time overhead for the user device 101 to acquire the resource configuration of the second primary cell.

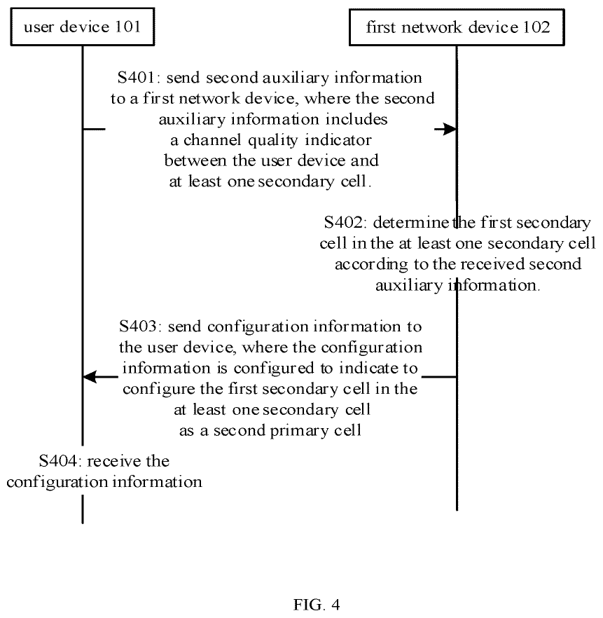

An embodiment of the present disclosure provides a method for transmitting configuration information, referring to FIG. 4. FIG. 4 is a method for transmitting configuration information according to an embodiment, as shown in FIG. 4. The method includes steps S401 to S404, specifically:
in step S401, a user device 101 sends second auxiliary information to a first network device 102, and the second auxiliary information includes a channel quality indicator between the user device 101 and at least one secondary cell.
in step S402, the first network device 102 determines the first secondary cell in the at least one secondary cell according to the received second auxiliary information.
in step S403, the first network device 102 sends configuration information to the user device 101, the configuration information is configured to indicate to configure the first secondary cell in the at least one secondary cell as a second primary cell, and the servicing cell of the user device 101 includes a first primary cell and the at least one secondary cell.
in step S404, the user device 101 receives the configuration information sent by the first network device 102.

In some possible embodiments, the network device corresponding to each secondary cell is the second network device 102, and thus the second auxiliary information may characterize a channel quality indicator between the user device 101 and the second network device 102 corresponding to each secondary cell.

In some possible embodiments, the channel quality indicator includes a Reference Signal Receiving Power (RSRP) or a Received Signal Strength Indication (RSSI).

In some possible embodiments, the first network device 102 may refer to the second auxiliary information reported by the user device 101 to determine the first secondary cell with a better channel quality in each secondary cell as the new primary cell, i.e., the second primary cell.

In some possible embodiments, the configuration information may not only include an instruction to configure the first secondary cell as the new primary cell; it may also include resource configuration for the first secondary cell, such as broadcast message configuration, PRACH configuration, mobility measurement configuration, etc,.

In an example, the configuration information carries an identifier of the first secondary cell.

In an embodiment of the present disclosure, the user device 101 reports the channel quality indicator between the user device 101 and each secondary cell by reporting the second auxiliary information to the first network device 102. Thus, the first network device 102 may refer to the second auxiliary information to determine the first secondary cell with a better channel quality as the new primary cell, effectively ensuring the service transmission quality in the sleep state of the first primary cell.

Moreover, in an embodiment of the present disclosure, when the configuration information includes the resource configuration of the first secondary cell, the user device 101 may acquire the resource configuration information of the second primary cell before switching to the second primary cell, thereby reducing the signaling interaction after switching and further saving the time overhead for the user device 101 to acquire the resource configuration of the second primary cell.

An embodiment of the present disclosure provides a method for transmitting configuration information, which includes steps S401′ to S404′, specifically:
in step S401′, a user device 101 sends first auxiliary information and second auxiliary information to a first network device 102, the first auxiliary information is configured to indicate the feature information recommended by the user device 101 for a secondary cell to serve as a primary cell, and the second auxiliary information includes a channel quality indicator between the user device 101 and the at least one secondary cell.
in step S402′, the first network device 102 determines the first secondary cell in at least one secondary cell according to the received first auxiliary information and second auxiliary information.
in step S403′, the first network device 102 sends configuration information to the user device 101, the configuration information is configured to indicate to configure the first secondary cell in at least one secondary cell as the second primary cell, and the servicing cell of the user device 101 includes the first primary cell and at least one secondary cell.
in step S404′, the user device 101 receives the configuration information sent by the first network device 102.

In some possible embodiments, a sequence in which the user device 101 sends the first auxiliary information and the second auxiliary information is not limited. For example, the first auxiliary information may be sent first, the second auxiliary information may be sent first, or both the first and second auxiliary information may be sent simultaneously. For example, according to a request sequence indicated by the request information of the first network device 102, the first auxiliary information and/or the second auxiliary information is sent.

In some possible embodiments, the first network device 102 determines n secondary cells, recommended by the user device 101, that may serve as the primary cell according to the first auxiliary information; and then determines a secondary cell with the best channel quality indicator in the n secondary cells as the first secondary cell according to the second auxiliary information.

In some possible embodiments, the first network device 102 determines n secondary cells whose channel quality indicator meets a parameter threshold according to the second auxiliary information; and then determines the secondary cell recommended by the user device 101 in the n secondary cells as the first secondary cell according to the first auxiliary information.

It may be understood that the first network device 102 may still refer to other information, such as the load of the secondary cell or whether it meets the setting condition for being the primary cell, in the process of making decisions with reference to the first auxiliary information and/or the second auxiliary information.

In an embodiment of the present disclosure, the first network device 102 may refer to the first auxiliary information and the second auxiliary information to comprehensively determine the first secondary cell, which is beneficial for selecting a suitable and better channel quality first secondary cell as the new primary cell.

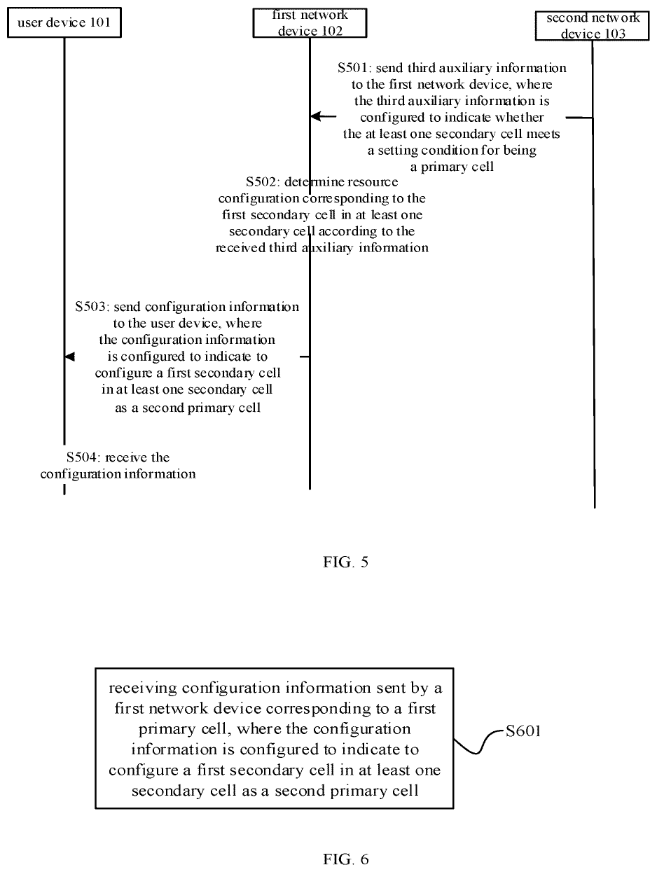

A method for transmitting configuration information is provided in an embodiment of the present disclosure, referring to FIG. 5. FIG. 5 is a method for transmitting configuration information according to an embodiment, as shown in FIG. 5. The method includes steps S501-S504, specifically:
in step S501, the first network device 102 receives third auxiliary information sent by a second network device 103 corresponding to at least one secondary cell, the third auxiliary information is configured to indicate whether the at least one secondary cell meets a setting condition for being a primary cell.
in step S502, the first network device 102 determines resource configuration corresponding to the first secondary cell in at least one secondary cell according to the received third auxiliary information.
in step S503, the first network device 102 sends configuration information to the user device 101, and the configuration information is configured to indicate to configure a first secondary cell in at least one secondary cell as a second primary cell, and a servicing cell of the user device 101 includes a first primary cell and the at least one secondary cell.
in step S504, the user device 101 receives the configuration information sent by the first network device 102.

In some possible embodiments, each secondary cell corresponds to one second network device 103. The second network device 103 may inform the first network device 102 whether its corresponding secondary cell may serve as the primary cell, for reference and decision-making by the first network device 102.

In some possible embodiments, for example, the setting condition met for serving as the primary cell includes at least one of the following:
supporting configuring PRACH;
broadcasting a specific type of system information block (SIB), such as at least one of SIB1, SIB2, SIB3, SIB4, or SIB5; or
including a synchronization signaling block (SSB) broadcast.

In an example, SIBI mainly carries information related to cell access and cell selection. SIB2 mainly carries public radio resource configuration related information, including PRACH configuration information. SIB3 carries public information related to intra-frequency, inter-frequency, and inter-RAT (Radio Access Technology) cell reselection. SIB4 carries neighboring cell information for intra-frequency cell reselection. SIB5 carries neighboring cell information for inter-frequency cell reselection.

In some possible embodiments, for example, the setting condition not met for serving as the primary cell includes at least one of the following:
not supporting configuring PRACH;
not broadcasting some types of system information or any system information; or
no synchronization signaling block (SSB) broadcast.

In some possible embodiments, the first network device 102 also receives the first auxiliary information and the second auxiliary information sent by the user device 101.

In some possible embodiments, the first network device 102 determines the first secondary cell based on the third auxiliary information, in combination with the first auxiliary information and/or the second auxiliary information.

In some possible embodiments, the first network device 102 determines that the setting condition for meeting as a primary cell based on the third auxiliary information, and selects the first secondary cell by combining the first auxiliary information and/or the second auxiliary information.

In an example, the first network device 102 determines n secondary cells that may serve as the primary cell according to the third auxiliary information. The first network device 102 determines the first secondary cell by combining the first auxiliary information and/or the second auxiliary information in the n secondary cells. For example, in the n secondary cells, the first network device 102 combines the first auxiliary information to determine part of the secondary cells recommended by the user device 101 that may serve as the primary cell, and then determines the secondary cell with the best channel quality in the part of the secondary cells as the first secondary cell according to the second auxiliary information.

In some possible embodiments, the first network device 102 may also combine the first auxiliary information and/or the second auxiliary information to select at least one secondary cell, and then combine the third auxiliary information to determine the first secondary cell in the at least one secondary cell.

In an embodiment of the present disclosure, the second network device 103 informs the first network device 102 whether the secondary cell corresponding to the second network device 103 has the condition to serve as the primary cell by reporting the third auxiliary information to the first network device 102. Thus, the first network device 102 may refer to the third auxiliary information to determine a suitable secondary cell as the new primary cell.

An embodiment of the present disclosure provides a method for receiving configuration information, which is executed by a user device 101. Referring to FIG. 6, FIG. 6 shows a method for receiving configuration information according to an embodiment. As shown in FIG. 6, the method includes step S601, specifically:
in step S601, the user device 101 receives configuration information sent by a first network device 102 corresponding to a first primary cell, the configuration information is configured to indicate to configure a first secondary cell in at least one secondary cell as a second primary cell, and a servicing cell of the user device 101 includes the first primary cell and the at least one secondary cell.

In some possible embodiments, the embodiment of the present disclosure is applied to a scenario where the first primary cell is dynamically turned off due to energy conservation, and step S201 is executed before the first primary cell is turned off, i.e., before the first primary cell enters the sleep state.

In some possible embodiments, the user device 101 may configure a plurality of cells as the servicing cells, and the servicing cell includes one primary cell (Pcell) and one or more secondary cells (Scell). The user device 101 uses the same Cell Radio Network Temporary Identifier (C-RNTI) in both the primary cell and the plurality of secondary cells.

The plurality of cells serving as the serving cells have been connected to the user device 101, and the user device 101 has acquired uplink and downlink synchronization of each cell in various serving cell.

In some possible embodiments, the first primary cell is configured to refer to an original primary cell of the user device 101, which is the dynamically-closed primary cell; the second primary cell refers to a new primary cell configured by the first network device 102 for the user device 101 after the first primary cell is dynamically closed, and the new primary cell is determined from at least one secondary cell.

The network device corresponding to the first primary cell is referred to as the first network device 102, and the network device corresponding to each secondary cell is referred to as the second network device 103.

In some possible embodiments, the configuration information may include an instruction to configure the first secondary cell as the new primary cell, and resource configuration for the first secondary cell. Thus, the user device 101 may configure a new primary cell such that the user device may transmit services in the second primary cell when the first primary cell is closed.

In an embodiment of the present disclosure, the user device 101 may acquire the first secondary cell configured as the second primary cell in the serving cell according to the configuration information sent by the first network device 102. Thus, when the first primary cell is closed, the first secondary cell that has already established a connection with the user device 101 may be configured as a new primary cell, reducing unnecessary handover processes for the user device 101 and effectively reducing the overhead of the user device 101.

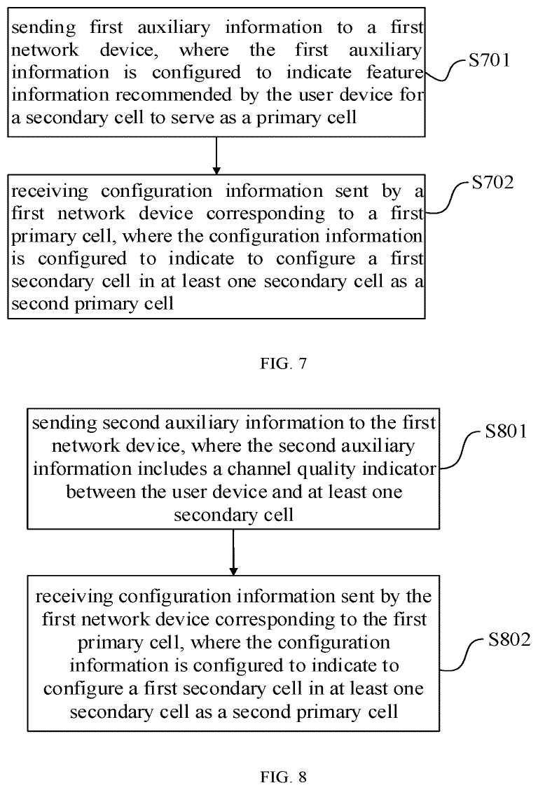

An embodiment of the present disclosure provides a method for receiving configuration information, which is executed by the user device 101. Referring to FIG. 7, FIG. 7 shows a method for receiving configuration information according to an embodiment. As shown in FIG. 7, the method includes steps S701-S702, specifically:
in step S701, the user device 101 sends first auxiliary information to a first network device 102, the first auxiliary information is configured to indicate feature information recommended by the user device for a secondary cell to serve as a primary cell.
in step S702, the user device 101 receives configuration information sent by a first network device 102 corresponding to a first primary cell, the configuration information is configured to indicate to configure a first secondary cell in at least one secondary cell as a second primary cell, and a servicing cell of the user device 101 includes the first primary cell and the at least one secondary cell.

In some possible embodiments, the user device 101 may recommend to the first network device 102 a frequency band or identification information of the secondary cell that may serve as the primary cell.

In some possible embodiments, the first network device 102 determines resource configuration of the first secondary cell according to the first auxiliary information, to send configuration information containing the resource configuration of the first secondary cell to the user device 101.

In an embodiment of the present disclosure, the user device 101 recommends to the first network device 102 feature information that may be served as the primary cell by reporting the first auxiliary information to the first network device 102. Thus, the first network device 102 may refer to the first auxiliary information, which is beneficial for determining a more suitable first secondary cell as the new primary cell.

An embodiment of the present disclosure provides a method for receiving configuration information, which is executed by the user device 101. The method includes steps S701 to S702, wherein the feature information includes at least one of the following:
an operating frequency band; or identification information.

In some possible embodiments, the operating frequency band recommended by the user device 101 may correspond to a preferred frequency band for service transmission of the user device 101.

In some possible embodiments, the operating frequency band recommended by the user device 101 may correspond to one or more secondary cells.

In an example, the user device 101 recommends a secondary cell on frequency band band 1 as the first secondary cell, and a secondary cell on frequency band band 1 is Scell 1.

In an example, the user device 101 recommends a secondary cell on frequency band band 1 as the first secondary cell, and the secondary cell on frequency band band 1 includes Scell 1 and Scell 2.

In some possible embodiments, the identification information may be a physical layer identification of the cell or a cell index identification. The cell index identification occupies less bits.

In an example, the user device 101 recommends the serving cell 1 with a cell index identification of 1 as the first secondary cell.

In some possible embodiments, the first network device 102 selects the first secondary cell with reference to the first auxiliary information.

In an embodiment of the present disclosure, the user device 101 reports recommended feature information, such as the frequency band and cell identification, that may be used as the primary cell for the first network device 102, providing reference first auxiliary information for the first network device 102.

An embodiment of the present disclosure provides a method for receiving configuration information, which is executed by the user device 101. Referring to FIG. 8, FIG. 8 shows a method for receiving configuration information according to an embodiment. As shown in FIG. 8, the method includes steps S801 to S802, specifically:
in step S801, the user device 101 sends second auxiliary information to the first network device 102, and the second auxiliary information includes a channel quality indicator between the user device 101 and at least one secondary cell.
in step S802, the user device 101 receives configuration information sent by the first network device 102 corresponding to the first primary cell, the configuration information is configured to indicate to configure a first secondary cell in at least one secondary cell as a second primary cell, and a servicing cell of the user device 101 includes the first primary cell and the at least one secondary cell.

In some possible embodiments, the network device corresponding to each secondary cell is the second network device 102, and thus the second auxiliary information may characterize the channel quality indicator between the user device 101 and the second network device 102 corresponding to each secondary cell.

In some possible embodiments, the channel quality indicator includes RSRP or RSSI.

In some possible embodiments, the first network device 102 determines resource configuration of the first secondary cell according to the second auxiliary information, and sends configuration information containing the resource configuration of the first secondary cell to the user device 101.

In an embodiment of the present disclosure, the user device 101 reports the channel quality indicator between the user device 101 and each secondary cell by reporting the second auxiliary information to the first network device 102. Thus, the first network device 102 may refer to the second auxiliary information to determine the first secondary cell with a better channel quality as the new primary cell, effectively ensuring the service transmission quality in the sleep state of the first primary cell.

An embodiment of the present disclosure provides a method for receiving configuration information, which is executed by the user device 101.

The method includes steps S701′ to S702, specifically:
in step S701′, in response to receiving request information from the first network device 102, the user device 101 sends the first auxiliary information to the first network device 102, and the first auxiliary information is configured to indicate the feature information recommended by the user device 101 for a secondary cell to serve as a primary cell.
in step S702, the user device 101 receives configuration information sent by a first network device 102 corresponding to a first primary cell, the configuration information is configured to indicate to configure a first secondary cell in at least one secondary cell as a second primary cell, and a servicing cell of the user device 101 includes the first primary cell and the at least one secondary cell.

Alternatively, the method may include steps S801′ to S802, specifically:
in step S801′, in response to receiving request information from the first network device 102, the user device 101 sends second auxiliary information to the first network device 102, and the second auxiliary information includes a channel quality indicator between the user device 101 and at least one secondary cell.
in step S802, the user device 101 receives configuration information sent by a first network device 102 corresponding to a first primary cell, the configuration information is configured to indicate to configure a first secondary cell in at least one secondary cell as a second primary cell, and a servicing cell of the user device 101 includes the first primary cell and the at least one secondary cell.

Alternatively, in response to receiving the request information from the first network device 102, the user device 101 sends the first auxiliary information and the second auxiliary information to the first network device 102.

In some possible embodiments, the first auxiliary information and the second auxiliary information correspond to different request information, or to different fields in the same request information.

In some possible embodiments, the user device 101 reports the first auxiliary information or the second auxiliary information to the first network device 102 after receiving the request information; alternatively, the user device 101 report the first auxiliary information and second auxiliary information after receiving the request information.

In some possible embodiments, the first network device 102 determines the first secondary cell by reference decision according to at least one of the first auxiliary information or the second auxiliary information.

In an embodiment of the present disclosure, the user device 101 reports the corresponding auxiliary information to the first network device 102 according to the request information from the first network device 102, in order to provide recommendations or references for the first network device 102, and more efficiently or reasonably determine the first secondary cell that may serve as the new primary cell.

An embodiment of the present disclosure provides a method for receiving configuration information, which is executed by the user device 101. The method includes steps S601-S602, specifically:
in step S601, the user device 101 receives configuration information sent by a first network device 102 corresponding to a first primary cell, the configuration information is configured to indicate to configure a first secondary cell in at least one secondary cell as a second primary cell, and a servicing cell of the user device 101 includes the first primary cell and the at least one secondary cell.
in step S602, the user device 101 sends indication information to the first network device 102, and the indication information is configured to indicate that the first secondary cell has been successfully configured as the second primary cell.

In some possible embodiments, the configuration information may include an instruction to configure the first secondary cell as the new primary cell, and resource configuration of the first secondary cell. The user device 101 configures the new primary cell according to the configuration information, and after successful configuration, reports the indication information to the first network device 102.

In some possible embodiments, the first network device 102 may dynamically shut down and enter sleep mode upon receiving the indication information to save energy consumption. At this point, the first primary cell corresponding to the first network device 102 enters a sleep state.

In an embodiment of the present disclosure, after successfully configuring a new primary cell, the user device 101 may promptly report to the first network device 102, such that the first network device 102 may be turned off in time and save power consumption.

An embodiment of the present disclosure provides a method for receiving configuration information, which is executed by the user device 101. The method includes steps S601 and S603, specifically:
in step S601, the user device 101 receives configuration information sent by a first network device 102 corresponding to a first primary cell, the configuration information is configured to indicate to configure a first secondary cell in at least one secondary cell as a second primary cell, and a servicing cell of the user device 101 includes the first primary cell and the at least one secondary cell.
in step S603, based on the configuration information, the user device 101 performs service transmission with the second primary cell.

In some possible embodiments, the configuration information may include an instruction to configure the first secondary cell as the new primary cell, and resource configuration for the first secondary cell. Thus, the user device 101 may perform a new primary cell configuration.

In some possible embodiments, after the successful configuration of the second primary cell, the second primary cell may send Radio Resource Control (RRC) connection reconfiguration information to the user device 101, such that the user device 101 may be configured with RRC configuration information that matches the new primary cell.

In some possible embodiments, after the user device 101 completes the RRC connection reconfiguration of the new primary cell, the user device 101 may perform the service transmission with the second primary cell, i.e., with the second network device 103 corresponding to the second primary cell.

In an embodiment of the present disclosure, when the first primary cell is closed, the user device 101 may skip the handover process and perform service transmission with the new primary cell in the serving cell, reducing the overhead of the user device 101.

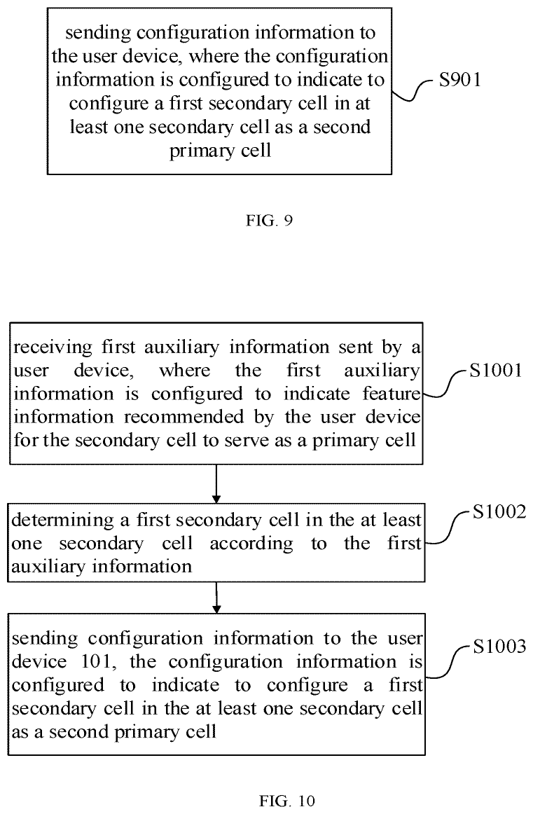

An embodiment of the present disclosure provides a method for sending configuration information, which is executed by the first network device 102. Referring to FIG. 9, FIG. 9 shows a method for sending configuration information according to an embodiment. As shown in FIG. 9, the method includes step S901, specifically:
in step S901, the first network device 102 sends configuration information to the user device 101, the configuration information is configured to indicate to configure a first secondary cell in at least one secondary cell as a second primary cell, and the servicing cell of the user device 101 includes the first primary cell and at least one secondary cell.

In some possible embodiments, the configuration information may include an instruction to configure the first secondary cell as the new primary cell, and resource configuration for the first secondary cell.

In some possible embodiments, the user device 101 may configure a plurality of cells as the servicing cells, and the servicing cell includes one primary cell (Pcell) and one or more secondary cells (Scell). The user device 101 uses the same Cell Radio Network Temporary Identifier (C-RNTI) in both the primary cell and the plurality of secondary cells.

The plurality of cells serving as the serving cells have been connected to the user device 101, and the user device 101 has acquired uplink and downlink synchronization of each cell in various serving cell.

In some possible embodiments, the first primary cell is configured to refer to an original primary cell of the user device 101, which is the dynamically-closed primary cell; the second primary cell refers to a new primary cell configured by the first network device 102 for the user device 101 after the first primary cell is dynamically closed, and the new primary cell is determined from at least one secondary cell.

The network device corresponding to the first primary cell is referred to as the first network device 102, and the network device corresponding to each secondary cell is referred to as the second network device 103.

In the embodiment of the present disclosure, the first network device 102 may send configuration information to the user device 101 to configure the first secondary cell in the serving cell as the second primary cell. Thus, when the first primary cell is closed, the first secondary cell that has already established a connection with the user device 101 may be configured as a new primary cell, reducing unnecessary handover processes for the user device 101 and effectively reducing the overhead of the user device 101.

An embodiment of the present disclosure provides a method for sending configuration information, which is executed by a first network device 102. Referring to FIG. 10, FIG. 10 shows a method for sending configuration information according to an embodiment. As shown in FIG. 10, the method includes steps S1001 to S1003, specifically:
in step S1001, a first network device 102 receives first auxiliary information sent by a user device 101, the first auxiliary information is configured to indicate feature information recommended by the user device for the secondary cell to serve as a primary cell;
in step S1002, the first network device 102 determines a first secondary cell in the at least one secondary cell according to the first auxiliary information.
in step S1003, the first network device 102 sends configuration information to the user device 101, the configuration information is configured to indicate to configure a first secondary cell in the at least one secondary cell as a second primary cell, and a servicing cell of the user device 101 includes the first primary cell and at least one secondary cell.

In some possible embodiments, the feature information includes at least one of the following:
an operating frequency band; or identification information.

In some possible embodiments, the first network device 102 determines resource configuration of the first secondary cell according to the first auxiliary information, to send configuration information containing the resource configuration of the first secondary cell to the user device 101.

In some possible embodiments, the first network device 102 uses a secondary cell recommended by the user device 101 as a first secondary cell according to the first auxiliary information, to use the first secondary cell as a new primary cell.

In some possible embodiments, the first network device 102 selects a secondary cell with the smallest load from the at least one secondary cell recommended by the user device 101 as the first secondary cell, to use the first secondary cell as a new primary cell.

In an embodiment of the present disclosure, the first network device 102 acquires the feature information recommended by the first network device 102 to serve as the primary cell according to the first auxiliary information reported by the user device 101. Thus, the first network device 102 may refer to the first auxiliary information, which is beneficial for determining a more suitable first secondary cell to be as the new primary cell.

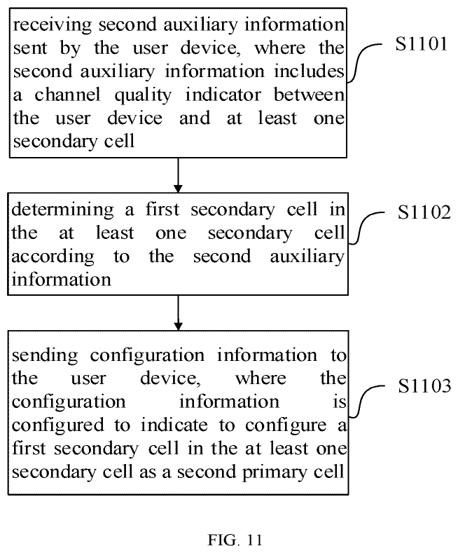

An embodiment of the present disclosure provides a method for sending configuration information, which is executed by a first network device 102. Referring to FIG. 11, FIG. 11 shows a method for sending configuration information according to an embodiment. As shown in FIG. 11, the method includes steps S1101 to 1103, specifically:
in step S1101, the first network device 102 receives second auxiliary information sent by the user device 101, the second auxiliary information includes a channel quality indicator between the user device 101 and at least one secondary cell.
in step S1102, the first network device 102 determines a first secondary cell in the at least one secondary cell according to the second auxiliary information.
in step 1103, the first network device 102 sends configuration information to the user device 101, the configuration information is configured to indicate to configure a first secondary cell in the at least one secondary cell as a second primary cell, and the servicing cell of the user device 101 includes the first primary cell and the at least one secondary cell.

Alternatively, the method may include steps S1101′ to 1103′, specifically:
Step S1101′, the first network device 102 receives first auxiliary information and second auxiliary information sent by the user device 101, the first auxiliary information is configured to indicate the feature information recommended by the user device for the secondary cell to serve as a primary cell, and the second auxiliary information includes a channel quality indicator between the user device 101 and at least one secondary cell.
Step S1102′, the first network device 102 determines a first secondary cell in the at least one secondary cell according to the first auxiliary information and the second auxiliary information.
Step S1103′, the first network device 102 sends configuration information to the user device 101, the configuration information is configured to indicate to configure a first secondary cell in the at least one secondary cell as a second primary cell, and the servicing cell of the user device 101 includes the first primary cell and the at least one secondary cell.

In some possible embodiments, the channel quality indicator include RSRP or RSSI.

In some possible embodiments, the first network device 102 may refer to the second auxiliary information reported by the user device 101 to determine the first secondary cell with a better channel quality in each secondary cell as the new primary cell, i.e., the second primary cell.

In some possible embodiments, the first network device 102 determines n secondary cells, recommended by the user device 101, that may serve as the primary cell according to the first auxiliary information; and then determines a secondary cell with the best channel quality indicator in the n secondary cells as the first secondary cell according to the second auxiliary information.

In some possible embodiments, the first network device 102 determines n secondary cells whose channel quality indicator meets a parameter threshold according to the second auxiliary information; and then determines the secondary cell recommended by the user device 101 in the n secondary cells as the first secondary cell according to the first auxiliary information.

It may be understood that the first network device 102 may still refer to other information, such as the load of the secondary cell or whether it meets the setting condition for being the primary cell, in the process of making decisions with reference to the first auxiliary information and/or the second auxiliary information.

In an embodiment of the present disclosure, the first network device 102 acquires the channel quality indicator between the user device 101 and each secondary cell according to the manner in which the user device 101 reports the second auxiliary information. Thus, the first network device 102 may refer to the first auxiliary information to determine the first secondary cell with better channel quality as the new primary cell, effectively ensuring the service transmission quality in the sleep state of the first primary cell.

An embodiment of the present disclosure provides a method for sending configuration information, which is executed by the first network device 102. The method includes step S1000:
in step S1000, the first network device 102 sends request information to the user device 101, the request information is configured to indicate to acquire auxiliary information of the user device 101, and the auxiliary information includes the first auxiliary information and/or the second auxiliary information.

The disclosed embodiments may further include steps S1001 to S1003, or steps S1101 to 1103, where step S1000 is executed before step S1001 or S1101.

In some possible embodiments, the first auxiliary information is configured to indicate the feature information recommended by the user device for the secondary cell to serve as a primary cell.

In some possible embodiments, the second auxiliary information includes a channel quality indicator between the user device 101 and at least one secondary cell.

In an embodiment of the present disclosure, the first network device 102 requests the user device 101 to report auxiliary information for reference by sending the request information, in order to more efficiently or reasonably determine the first secondary cell that may serve as the new primary cell.

An embodiment of the present disclosure provides a method for sending configuration information, which is executed by the first network device 102. The method includes steps S901-S902, specifically:
in step S901, the first network device 102 sends configuration information to the user device 101, the configuration information is configured to indicate to configure the first secondary cell in the at least one secondary cell as a second primary cell, and the servicing cell of the user device 101 includes a first primary cell and the at least one secondary cell.
in step S902, the first network device 102 receives indication information sent by the user device 101, and the indication information is configured to indicate that the first secondary cell has been successfully configured as the second primary cell.

In some possible embodiments, the user device 101 configures a new primary cell according to the configuration information, and after successful configuration, reports the indication information to the first network device 102.

In some possible embodiments, the first network device 102 may dynamically shut down and enter sleep mode upon receiving the indication information to save energy consumption. At this point, the first primary cell corresponding to the first network device 102 enters a sleep state.

In some possible embodiments, after receiving the indication information or determining the resource configuration of the first secondary cell, data forwarding may be performed between the first network device 102 and the second network device 103 corresponding to the first secondary cell.

For example, the first primary cell sends the service data that has not been completely transmitted between the first primary cell and the user device 101 to the second primary cell, and the second primary cell continues to transmit the service data to the user device 101.

In an embodiment of the present disclosure, after learning that the user device 101 has successfully configured a new primary cell, the first network device 102 may be turned off in time to save power consumption.

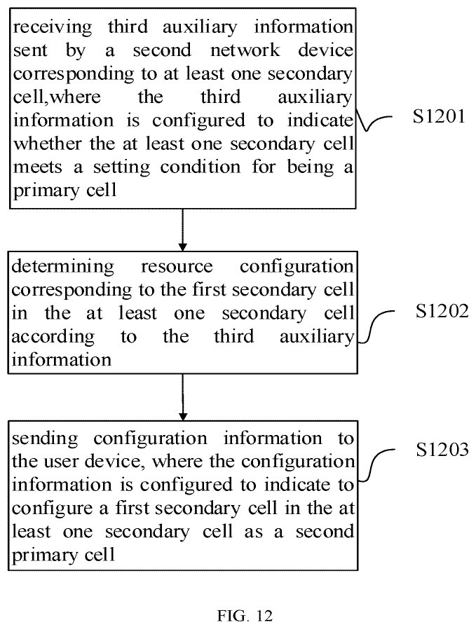

An embodiment of the present disclosure provides a method for sending configuration information, which is executed by the first network device 102. Referring to FIG. 12, FIG. 12 shows a method for sending configuration information according to an embodiment. As shown in FIG. 12, the method includes steps S1201 to 1203, specifically:
in step S1201: the first network device 102 receives third auxiliary information sent by a second network device 103 corresponding to at least one secondary cell, the third auxiliary information is configured to indicate whether the at least one secondary cell meets a setting condition for being a primary cell.
in step S1202, the first network device 102 determines resource configuration corresponding to the first secondary cell in the at least one secondary cell according to the third auxiliary information.
in step S1203, the first network device 102 sends configuration information to the user device 101, the configuration information is configured to indicate to configure a first secondary cell in the at least one secondary cell as a second primary cell, and the servicing cell of the user device 101 includes the first primary cell and the at least one secondary cell.

Alternatively, the method may include steps S1201′ to 1204′, specifically:
in step S1201′, the first network device 102 receives third auxiliary information sent by a second network device 103 corresponding to at least one secondary cell, the third auxiliary information is configured to indicate whether the at least one secondary cell meets a setting condition for being a primary cell.
in step S1202′, the first network device 102 receives first auxiliary information and second auxiliary information sent by the user device 101, the first auxiliary information is configured to indicate the feature information recommended by the user device for the secondary cell to serve as a primary cell, and the second auxiliary information includes a channel quality indicator between the user device 101 and the at least one secondary cell.
in step S1203′, the first network device 102 determines the first secondary cell in the at least one secondary cell according to the third auxiliary information, and at least one of the first auxiliary information and the second auxiliary information.
in step S1204′, the first network device 102 sends configuration information to the user device 101, the configuration information is configured to indicate to configure a first secondary cell in the at least one secondary cell as a second primary cell, and the servicing cell of the user device 101 includes the first primary cell and the at least one secondary cell.

In some possible embodiments, each secondary cell corresponds to one second network device 103. The second network device 103 may inform the first network device 102 whether its corresponding secondary cell may serve as the primary cell, for reference and decision-making by the first network device 102.

In some possible embodiments, for example, the setting condition not met for serving as the primary cell includes at least one of the following:
not supporting configuring PRACH;
not broadcasting some types of system information or any system information; or
no synchronization signaling block (SSB) broadcast.

In some possible embodiments, the first network device 102 may determine the first secondary cell according to at least one of the first auxiliary information, the second auxiliary information, or the third auxiliary information.

In some possible embodiments, the first network device 102 determines that the setting condition for meeting as a primary cell based on the third auxiliary information, and selects the first secondary cell by combining the first auxiliary information and/or the second auxiliary information.

In an example, the first network device 102 determines n secondary cells that may serve as the primary cell according to the third auxiliary information. The first network device 102 determines the first secondary cell by combining the first auxiliary information and/or the second auxiliary information in the n secondary cells. For example, in the n secondary cells, the first network device 102 combines the first auxiliary information to determine part of the secondary cells recommended by the user device 101 that may serve as the primary cell, and then determines the secondary cell with the best channel quality in the part of the secondary cells as the first secondary cell according to the second auxiliary information.

In an embodiment of the present disclosure, the first network device 102 acquires whether the secondary cell corresponding to the second network device 103 meets the condition to serve as the primary cell according to the third auxiliary information reported by the second network device 103. Thus, the first network device 102 may refer to the third auxiliary information to determine a suitable secondary cell as the new primary cell.

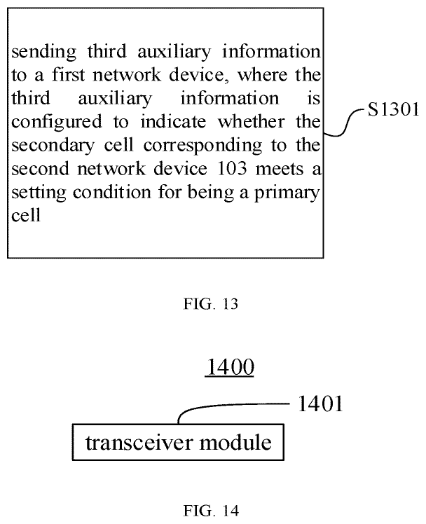

An embodiment of the present disclosure provides a method for sending configuration information, which is executed by a second network device 103. Referring to FIG. 13, FIG. 13 shows a method for sending configuration information according to an embodiment. As shown in FIG. 13, the method includes step 1301, specifically:
in step 1301, a second network device 103 sends third auxiliary information to a first network device 102, the third auxiliary information is configured to indicate whether the secondary cell corresponding to the second network device 103 meets a setting condition for being a primary cell.

In an embodiment of the present disclosure, the second network device 103 sends the third auxiliary information to the first network device 102 to inform whether the corresponding secondary cell may serve as the primary cell, such that the first network device 102 may reasonably determine a more suitable second primary cell, in order to reduce the overhead of the handover process of the user device 101.

An embodiment of the present disclosure provides a method for sending configuration information, which is executed by a second network device 103. The method includes step S1301′, specifically:
in step 1301′, in response to that a secondary cell corresponding to a second network device 103 is a first secondary cell, the second network device 103 sends radio resource control RRC connection reconfiguration information to the user device 101.

In some possible embodiments, in the scenario where the first primary cell is closed, the first network device 102 configures the first secondary cell as the new primary cell, i.e., the second primary cell.

In some possible embodiments, after the user device 101 completes the RRC connection reconfiguration of the new primary cell, the user device 101 may perform the service transmission with the second primary cell, i.e., with the second network device 103 corresponding to the second primary cell.

In an embodiment of the present disclosure, the second network device 103 sends the RRC connection reconfiguration information to configure the user device 101 with RRC configuration information that matches the new primary cell.

Based on the same concept as the above method embodiments, an embodiment of the present disclosure also provides an apparatus for receiving configuration information, which may have the functions of the user device 101 in the above method embodiments and may be configured to execute the steps provided by the user device 101 in the above method embodiments. The functions may be implemented through hardware, or by executing corresponding software through software or hardware. The hardware or software includes one or more modules corresponding to the above functions.

In a possible embodiment, the apparatus 1400 shown in FIG. 14 may serve as the user device 101 involved in the above method embodiments and execute the steps performed by the user device 101 in the above method embodiments. As shown in FIG. 14, the apparatus 1400 may include a transceiver module 1401, and the transceiver module 1401 may be configured to support the communication apparatus for communication.

When executing the step implemented by the user device 101, the transceiver module 1401 is configured to receive configuration information sent by the first network device 102 corresponding to the first primary cell, the configuration information is configured to indicate to configure the first secondary cell in at least one secondary cell as the second primary cell, and the serving cell of the user device 101 includes the first primary cell and at least one secondary cell.

In some possible embodiments, the transceiver module 1401 is further configured to send first auxiliary information to the first network device 102, where the first auxiliary information is configured to indicate the feature information recommended by the user device 101 for the secondary cell to serve as the primary cell.

In some possible embodiments, the feature information includes at least one of the following:
an operating frequency band; or identification information.

In some possible embodiments, the transceiver module 1401 is further configured to send second auxiliary information to the first network device 102, where the second auxiliary information includes a channel quality indicator between the user device 101 and the at least one secondary cell.

In some possible embodiments, the transceiver module 1401 is further configured to send auxiliary information to the first network device 102 in response to receiving request information from the first network device 102, where the auxiliary information includes first auxiliary information and/or second auxiliary information.

In some possible embodiments, the transceiver module 1401 is further configured to send indication information to the first network device 102, and the indication information is configured to indicate that the first secondary cell has been successfully configured as the second primary cell.

In some possible embodiments, the device further includes a processing module coupled to the transceiver module, and the processing module is configured to perform service transmission with the second primary cell according to the configuration information.

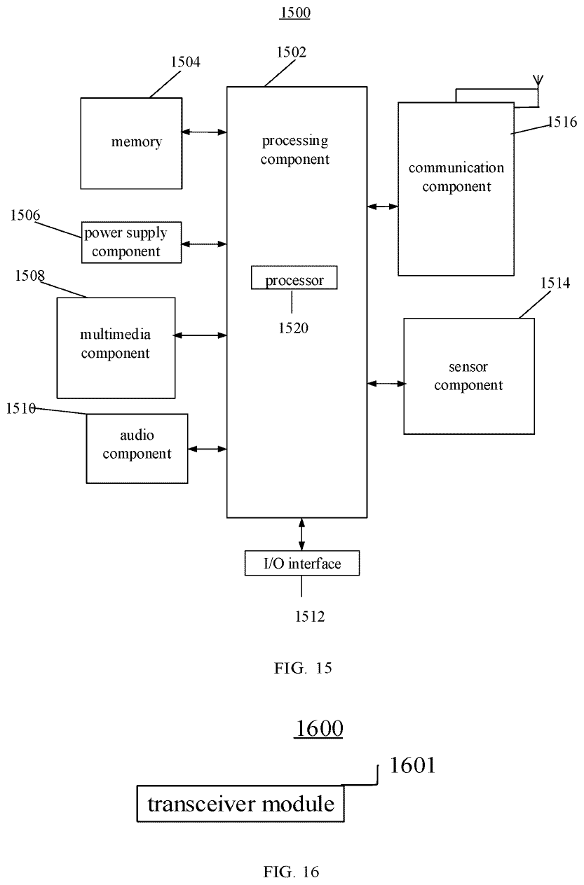

When the apparatus for receiving configuration information is the user device 101, the structure of the communication apparatus may also be as shown in FIG. 15. The communication apparatus 1500 may be a mobile phone, a computer, a digital broadcast terminal, a message transceiver device, a game console, a tablet device, a medical device, a fitness device, a personal digital assistant, etc.

Referring to FIG. 15, the apparatus 1500 may include one or more of the following components: a processing component 1502, a memory 1504, a power supply component 1506, a multimedia component 1508, an audio component 1510, an input/output (I/O) interface 1512, a sensor component 1514, and a communication component 1516.

The processing component 1502 generally controls the overall operation of the apparatus 1500, such as operations associated with display, telephone calls, data communications, camera operations, and recording operations. The processing component 1502 may include one or more processors 1520 to execute instructions to complete all or part of the steps of the foregoing methods. In addition, the processing component 1502 may include one or more modules to facilitate interaction between the processing component 1502 and other components. For example, the processing component 1502 may include a multimedia module to facilitate interaction between the multimedia component 1508 and the processing component 1502.

The memory 1504 is configured to store various types of data to support operations at the apparatus 1500. Examples of such data include instructions for any application or method operating on apparatus 1500, contact data, phonebook data, messages, pictures, videos, or the like. The memory 1504 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply component 1506 provides electrical power to various components of apparatus 1500. The power supply component 1506 may include a power management system, one or more power sources, and other components associated with generating, managing, and distributing power for apparatus 1500.

The multimedia component 1508 includes a screen providing an output interface between the apparatus 1500 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding, and gestures on the touch panel. The touch sensor may not only sense a boundary of the touching or sliding action, but also detect a duration and pressure associated with the touching or sliding action. In some embodiments, the multimedia component 1508 includes a front-facing camera and/or a rear-facing camera. When the apparatus 1500 is in an operation mode, such as a photographing mode or a video mode, the front-facing camera and/or the rear-facing camera may receive external multimedia data. Each of the front-facing camera and/or the rear-facing camera may be a fixed optical lens system, or may have a focal length and an optical zoom capability.

The audio component 1510 is configured to output and/or input an audio signal. For example, the audio component 1510 includes a microphone (MIC) configured to receive an external audio signal when the apparatus 1500 is in an operating mode, such as a call mode, a recording mode, and a speech recognition mode. The received audio signal may be further stored in the memory 1504 or transmitted via the communication component 1516. In some embodiments, the audio component 1510 further includes a speaker configured to output an audio signal.

The I/O interface 1512 provides an interface between the processing component 1502 and a peripheral interface module, and the peripheral interface module may be a keyboard, a click wheel, a button, or the like. The button may include, but is not limited to, a home button, a volume button, a start button, and a lock button.

The sensor component 1514 includes one or more sensors for providing status assessments of various aspects of the apparatus 1500. For example, the sensor component 1514 may detect the open/closed state of the apparatus 1500, and the relative positioning of the components; for example, these components may be the display and the keypad of the apparatus 1500. The sensor component 1514 may also detect the position change of the apparatus 1500 or a component of the apparatus 1500, the presence or absence of contact between the user and the apparatus 1500, the orientation or acceleration/deceleration of the apparatus 1500, and the temperature change of the apparatus 1500. The sensor component 1514 may include a proximity sensor configured to detect the presence of nearby objects without any physical contact. The sensor component 1514 may also include an optical sensor, such as a CMOS or CCD image sensor, for use in an imaging application. In some embodiments, the sensor component 1514 may further include an acceleration sensor, a gyroscope sensor, a magnetic sensor, a pressure sensor, or a temperature sensor.

The communication component 1516 is configured to facilitate wired or wireless communication between the apparatus 1500 and other devices. The apparatus 1500 may access a wireless network based on a communication standard, such as WiFi, 2G or 3G, or a combination of them. In some embodiments, the communication component 1516 receives broadcast signals or broadcast related information from an external broadcast management system via a broadcast channel. In some embodiments, the communication component 1516 further includes a near field communication (NFC) module to facilitate short-range communication. For example, the NFC module may be implemented based on a radio frequency identification (RFID) technology, an infrared data association (IrDA), an ultra-wideband (UWB) technology, a Bluetooth (BT) technology, and other technologies.

In some embodiments, the apparatus 1500 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for performing the foregoing methods.

In some embodiments, there is further provided a non-transitory computer-readable storage medium including an instruction, for example, a memory 1504 including an instruction. The instruction may be executed by the processor 1520 of the apparatus 1500 to complete the foregoing method. For example, the non-transitory computer-readable storage medium may be a ROM, a random access memory (RAM), a CD-ROM, a magnetic tape, a floppy disk, an optical data storage device, etc.

Based on the same concept as the above method embodiments, an embodiment of the present disclosure also provides an apparatus for sending configuration information, which may have the functions of the network device 102 in the above method embodiments and may be configured to perform the steps provided by the network device 102 in the above method embodiments. The functions may be implemented through hardware, or by executing corresponding software through software or hardware. The hardware or software includes one or more modules corresponding to the above functions.

In a possible embodiment, the communication apparatus 1600 shown in FIG. 16 may serve as the first network device 102 involved in the above method embodiment and perform the steps performed by the first network device 102 in the above method embodiment. As shown in FIG. 16, the communication apparatus 1600 may include a transceiver module 1601, and the transceiver module 1601 may be configured to support the communication apparatus for communication. The transceiver module 1601 may have wireless communication functions, such as being capable of communicating with other communication apparatus through a wireless air interface.

When executing the steps implemented by the first network device 102, the transceiver module 1601 is configured to send configuration information to the user device 101, the configuration information is configured to indicate to configure the first secondary cell in at least one secondary cell as the second primary cell, and a servicing cell of the user device includes the first primary cell and the at least one secondary cell.

In some possible embodiments, the transceiver module 1601 is further configured to receive the first auxiliary information sent by the user device, where the first auxiliary information is configured to indicate the feature information recommended by the user device for the secondary cell to serve as the primary cell;

The apparatus further includes a processing module coupled to the transceiver module 1601. The processing module is configured to determine the first secondary cell in the at least one secondary cell according to the first auxiliary information.

In some possible embodiments, the transceiver module 1601 is further configured to receive the second auxiliary information sent by the user device, where the second auxiliary information includes a channel quality indicator between the user device and the at least one secondary cell;

The processing module is configured to determine the first secondary cell in the at least one secondary cell according to the first auxiliary information and/or the second auxiliary information.

In some possible embodiments, the transceiver module 1601 is further configured to send request information to the user device, the request information is configured to indicate to acquire the auxiliary information of the user device, the auxiliary information includes first auxiliary information and/or second auxiliary information.

In some possible embodiments, the transceiver module 1601 is further configured to receive the indication information sent by the user device, and the indication information is configured to indicate that the first secondary cell has been successfully configured as the second primary cell.

In some possible embodiments, the transceiver module 1601 is further configured to receive the third auxiliary information sent by the second network device corresponding to the at least one secondary cell, where the third auxiliary information is configured to indicate whether the at least one secondary cell meets the setting condition for being the primary cell.

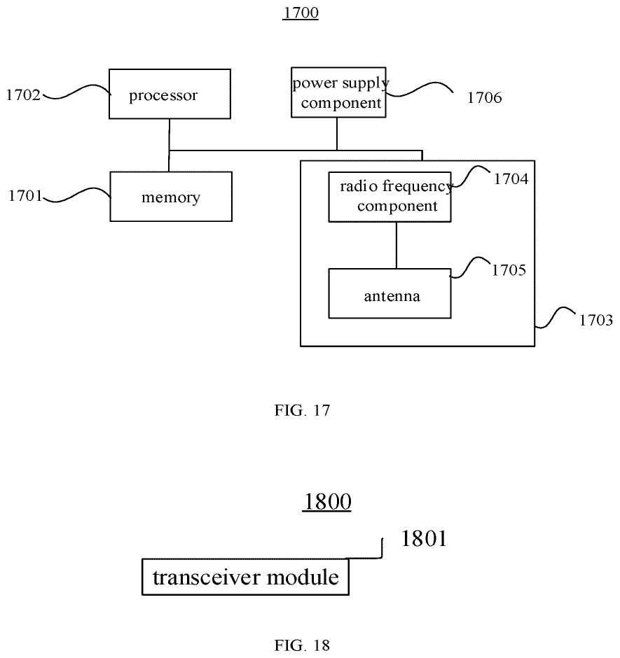

When the communication apparatus is a first network device 102, the structure of the communication apparatus may also be as shown in FIG. 17. A base station is used as an example to illustrate the structure of the communication apparatus. As shown in FIG. 17, the communication apparatus 1700 includes a memory 1701, a processor 1702, a transceiver component 1703, and a power supply component 1706. The memory 1701 is coupled to the processor 1702, and may be configured to store programs and data necessary for the communication apparatus 1700 to implement the various functions. The processor 1702 is configured to support the communication apparatus 1700 to perform corresponding functions in the foregoing method, and the functions may be implemented by invoking the programs stored in the memory 1701. The transceiver component 1703 may be a wireless transceiver, and may be configured to support the communication apparatus 1700 to receive signaling and/or data, and send signaling and/or data via a wireless air interface. The transceiver component 1703 may also be referred to as a transceiver unit or a communication unit. The transceiver component 1703 may include a radio frequency component 1704 and one or more antennas 1705. The radio frequency component 1704 may be a remote radio unit (RRU), and may be specifically configured for transmission of radio frequency signals and conversion between radio frequency signals and baseband signals. The one or more antennas 1705 may be specifically configured to transmit and receive radio frequency signals.

When the communication apparatus 1700 needs to send data, the processor 1702 may perform baseband processing on the data to be sent and then output the baseband signal to the radio frequency unit; the radio frequency unit performs radio frequency processing on the baseband signal and then sends the radio frequency signal in the form of electromagnetic waves through the antenna. When the data is sent to the communication apparatus 1700, the radio frequency unit receives the radio frequency signal through the antenna, converts the radio frequency signal into a baseband signal, and outputs the baseband signal to the processor 1702; and the processor 1702 converts the baseband signal into data and performs processing on the data.

Based on the same concept as the above method embodiments, an embodiment of the present disclosure also provides an apparatus for sending configuration information, and the apparatus may have the functions of the second network device 103 in the above method embodiments and may be configured to perform the steps provided by the second network device 103 in the above method embodiments. This functions may be implemented through hardware, or by executing corresponding software through software or hardware. The hardware or software includes one or more modules corresponding to the above functions.

In a possible embodiment, the communication apparatus 1800 shown in FIG. 18 may serve as the second network device 103 involved in the above method embodiments and perform the steps performed by the second network device 103 in the above method embodiments. As shown in FIG. 18, the communication apparatus 1800 may include a transceiver module 1801, and the transceiver module may be configured to support the communication apparatus for communication. The transceiver module 1801 may have wireless communication functions, such as being capable of communicating wirelessly with other communication apparatus through a wireless air interface.

When executing the steps implemented by the second network device 103, the transceiver module 1801 is configured to send the third auxiliary information to the first network device 102, and the third auxiliary information is configured to indicate whether the secondary cell corresponding to the second network device 103 meets the setting condition for being the primary cell.

In some possible embodiments, the transceiver module 1801 is further configured to send radio resource control RRC connection reconfiguration information to the user device in response to that the second network device corresponding to the first secondary cell is the first secondary cell.

When the communication apparatus is the second network device 103, its structure may also refer to FIG. 17, which will not be repeated here.

In a first aspect, the present disclosure provides a method for receiving configuration information, performed by a user device, including:
receiving configuration information sent by a first network device corresponding to a first primary cell, where the configuration information is configured to indicate to configure a first secondary cell in at least one secondary cell as a second primary cell, and a serving cell of the user device includes the first primary cell and the at least one secondary cell.

In the method of the present disclosure, the user device may acquire the first secondary cell configured as the second primary cell in the serving cell according to the configuration information sent by the first network device. Thus, when the first primary cell is closed, the first secondary cell that has already established a connection with the user device may be configured as a new primary cell, reducing unnecessary handover processes for the user device and effectively reducing the overhead of the user device.

In some possible embodiments, the method further includes:
sending first auxiliary information to the first network device, where the first auxiliary information is configured to indicate feature information recommended by the user device for a secondary cell to serve as a primary cell.

In some possible embodiments, the feature information includes at least one of following:
an operating frequency band; or identification information.

In some possible embodiments, the method further includes:
sending second auxiliary information to the first network device, where the second auxiliary information includes a channel quality indicator between the user device and the at least one secondary cell.

In some possible embodiments, the method further includes:
sending, in response to receiving request information of the first network device, auxiliary information to the first network device, where the auxiliary information includes first auxiliary information and/or second auxiliary information.

In some possible embodiments, the method further includes:
sending indication information to the first network device, where the indication information is configured to indicate that the first secondary cell has been successfully configured as the second primary cell.

In some possible embodiments, the method further includes:
performing, based on configuration information, service transmission with the second primary cell.

In a second aspect, the present disclosure provides a method for sending configuration information, performed by a first network device, including:
sending configuration information to a user device, where the configuration information is configured to indicate to configure a first secondary cell in at least one secondary cell as a second primary cell, and a serving cell of the user device includes a first primary cell and the at least one secondary cell.

In the method of the present disclosure, the first network device may send the configuration information to the user device to configure the first secondary cell in the serving cell as the second primary cell. Thus, when the first primary cell is closed, the first secondary cell that has already established a connection with the user device may be configured as the new primary cell, reducing unnecessary handover processes for the user device and effectively reducing the overhead of the user device.

In some possible embodiments, the method further includes:
receiving first auxiliary information sent by the user device, where the first auxiliary information is configured to indicate feature information recommended by the user device for a secondary cell to serve as a primary cell; and determining, according to the first auxiliary information, the first secondary cell in the at least one secondary cell.

In some possible embodiments, the method further includes:
receiving second auxiliary information sent by the user device, where the second auxiliary information includes a channel quality indicator between the user device and the at least one secondary cell; and determining, according to first auxiliary information and/or the second auxiliary information, the first secondary cell in the at least one secondary cell.

In some possible embodiments, the method further includes:
sending request information to the user device, where the request information is configured to indicate to acquire auxiliary information of the user device, and the auxiliary information includes first auxiliary information and/or second auxiliary information.

In some possible embodiments, the method further includes:
receiving indication information sent by the user device, where the indication information is configured to indicate that the first secondary cell has been successfully configured as the second primary cell.

In some possible embodiments, the method further includes:
receiving third auxiliary information sent by a second network device corresponding to the at least one secondary cell, where the third auxiliary information is configured to indicate whether the at least one secondary cell meets a setting condition for being the primary cell.

In a third aspect, the present disclosure provides a method for sending configuration information, performed by a second network device, including:
sending third auxiliary information to a first network device, where the third auxiliary information is configured to indicate whether a secondary cell corresponding to the second network device meets a setting condition for being a primary cell.

In the method of the present disclosure, the second network device sends the third auxiliary information to the first network device to inform whether the corresponding secondary cell may serve as the primary cell, such that the first network device may reasonably determine a more suitable second primary cell, in order to reduce the overhead of the handover process of the user device.

In some possible embodiments, the method further includes:
sending, in response to that the secondary cell corresponding to the second network device is a first secondary cell, radio resource control RRC connection reconfiguration information to a user device.

In a fourth aspect, the present disclosure provides an apparatus for receiving configuration information, the apparatus may be configured to perform the steps performed by the user device in the first aspect or any possible design of the first aspect. The user device may achieve various functions in the above methods through hardware structure, software modules, or a combination of hardware structure and software modules.

When implementing the apparatus shown in the fourth aspect through software modules, the apparatus may include a transceiver module, where the transceiver module may be configured to support the communication apparatus for communication.

When performing the steps described in the first aspect above, the transceiver module is configured to receive configuration information sent by a first network device corresponding to a first primary cell, where the configuration information is configured to indicate to configure a first secondary cell in at least one secondary cell as a second primary cell, and a serving cell of the user device includes the first primary cell and the at least one secondary cell.

In a fifth aspect, the present disclosure provides an apparatus for transmitting configuration information, the apparatus may be configured to perform the steps performed by the first network device in the second aspect or any possible design of the second aspect. The first network device may achieve various functions in the above methods through hardware structure, software modules, or a combination of hardware structure and software modules.

When implementing the apparatus shown in the fifth aspect through software modules, the apparatus may include a transceiver module, where the transceiver module may be configured to support the communication apparatus for communication.

When performing the steps described in the second aspect above, the transceiver module is configured to send configuration information to a user device, where the configuration information is configured to indicate to configure a first secondary cell in at least one secondary cell as a second primary cell, and a serving cell of the user device includes a first primary cell and the at least one secondary cell.

In a sixth aspect, the present disclosure provides an apparatus for transmitting configuration information, the apparatus may be configured to perform the steps performed by the second network device in the third aspect or any possible design of the third aspect. The second network device may implement the functions of the above methods through hardware structure, software modules, or a combination of hardware structure and software modules.

When implementing the apparatus shown in the sixth aspect through software modules, the apparatus may include a transceiver module, wherein the transceiver module may be configured to support communication of the communication apparatus.

When performing the steps described in the third aspect above, the transceiver module is configured to send third auxiliary information to a first network device, where the third auxiliary information is configured to indicate whether a secondary cell corresponding to the second network device meets a setting condition for being a primary cell.

In a seventh aspect, the present disclosure provides a communication apparatus including a processor and a memory, where the memory is configured to store computer programs; and the processor is configured to execute the computer program to implement the first aspect or any possible design of the first aspect.

In an eighth aspect, the present disclosure provides a communication apparatus including a processor and a memory, where the memory is configured to store computer programs; the processor is configured to execute the computer program to implement the second aspect or any possible design of the second aspect.

In a ninth aspect, the present disclosure provides a communication apparatus including a processor and a memory, where the memory is configured to store computer programs; the processor is configured to execute the computer program to implement the third aspect or any possible design of the third aspect.

In a tenth aspect, the present disclosure provides a non-transitory computer-readable storage medium storing instructions (or computer programs, programs) that, when invoked and executed on a computer, cause the computer to perform the first aspect or any possible design of the first aspect.

In an eleventh aspect, the present disclosure provides a non-transitory computer-readable storage medium storing instructions (or computer programs, programs) that, when invoked and executed on a computer, cause the computer to perform the second aspect or any possible design of the second aspect.

In a twelfth aspect, the present disclosure provides a non-transitory computer-readable storage medium storing instructions (or computer programs, programs) that, when invoked and executed on a computer, cause the computer to perform the third aspect or any possible design of the third aspect.

Other embodiments of the embodiments of the present disclosure will be apparent to those skilled in the art from consideration of the specification and practice of the present disclosure. The present disclosure is intended to cover any variations, uses, or adaptations of the embodiments of the present disclosure following the general principles of the embodiments of the present disclosure and including common general knowledge or conventional technical means in the art not disclosed in the present disclosure. The description and embodiments are considered as examples only, with the true scope and spirit of the embodiments of the present disclosure being indicated by the following claims.

It should be understood that the embodiments of the present disclosure are not limited to the precise structures that have been described above and shown in the accompanying drawings, and various modifications and changes may be made without departing from the scope of the embodiments of the present disclosure. The scope of the embodiments of the present disclosure is limited only by the appended claims.

### INDUSTRIAL APPLICABILITY

In the embodiments of the present disclosure, the user device may acquire the first secondary cell configured as the second primary cell in the serving cell according to the configuration information sent by the first network device. Thus, when the first primary cell is closed, the first secondary cell that has already established a connection with the user device may be configured as a new primary cell, reducing unnecessary handover processes for the user device and effectively reducing the overhead of the user device.

1. A method for receiving configuration information, performed by a user device, comprising:
receiving configuration information sent by a first network device corresponding to a first primary cell, wherein the configuration information is configured to indicate to configure a first secondary cell in at least one secondary cell as a second primary cell, and a serving cell of the user device comprises the first primary cell and the at least one secondary cell.

2. The method according to claim 1, further comprising:
sending first auxiliary information to the first network device, wherein the first auxiliary information is configured to indicate feature information recommended by the user device for a secondary cell to serve as a primary cell.

3. The method according to claim 2, wherein the feature information comprises at least one of following:
an operating frequency band; or
identification information.

4. The method according to claim 1, further comprising:
sending second auxiliary information to the first network device, wherein the second auxiliary information comprises a channel quality indicator between the user device and the at least one secondary cell.

5. The method according to claim 1, further comprising:
sending, in response to receiving request information of the first network device, auxiliary information to the first network device, wherein the auxiliary information comprises at least one of first auxiliary information or second auxiliary information.

6. The method according to claim 1, further comprising:
sending indication information to the first network device, wherein the indication information is configured to indicate that the first secondary cell has been successfully configured as the second primary cell.

7. The method according to claim 1, further comprising:
performing, based on configuration information, service transmission with the second primary cell.

8. A method for sending configuration information, performed by a first network device, comprising:
sending configuration information to a user device, wherein the configuration information is configured to indicate to configure a first secondary cell in at least one secondary cell as a second primary cell, and a serving cell of the user device comprises a first primary cell and the at least one secondary cell.

9. The method according to claim 8, further comprising:
receiving first auxiliary information sent by the user device, wherein the first auxiliary information is configured to indicate feature information recommended by the user device for a secondary cell to serve as a primary cell; and
determining, according to the first auxiliary information, the first secondary cell in the at least one secondary cell.

10. The method according to claim 8, further comprising:
receiving second auxiliary information sent by the user device, wherein the second auxiliary information comprises a channel quality indicator between the user device and the at least one secondary cell; and
determining, according to at least one of first auxiliary information or the second auxiliary information, the first secondary cell in the at least one secondary cell.

11. The method according to claim 8, further comprising:
sending request information to the user device, wherein the request information is configured to indicate to acquire auxiliary information of the user device, and the auxiliary information comprises at least one of first auxiliary information or second auxiliary information.

12. The method according to claim 8, further comprising:
receiving indication information sent by the user device, wherein the indication information is configured to indicate that the first secondary cell has been successfully configured as the second primary cell.

13. The method according to claims 8, further comprising:
receiving third auxiliary information sent by a second network device corresponding to the at least one secondary cell, wherein the third auxiliary information is configured to indicate whether the at least one secondary cell meets a setting condition for being the primary cell.

14. A method for sending configuration information, performed by a second network device, comprising:
sending third auxiliary information to a first network device, wherein the third auxiliary information is configured to indicate whether a secondary cell corresponding to the second network device meets a setting condition for being a primary cell.

15. The method according to claim 14, further comprising:
sending, in response to that the secondary cell corresponding to the second network device is a first secondary cell, radio resource control (RRC) connection reconfiguration information to a user device.

16-18. (canceled)

19. A communication apparatus comprising a processor and a memory, wherein
the memory is configured to store computer programs; and
the processor is configured to execute the computer program to implement the method according to claim 1.

20. A communication apparatus comprising a processor and a memory, wherein
the memory is configured to store computer programs; and
the processor is configured to execute the computer program to implement the method according to claim 8.

21. A communication apparatus comprising a processor and a memory, wherein
the memory is configured to store computer programs; and
the processor is configured to execute the computer program to implement the method according to claim 14.

22-24. (canceled)

25. The communication apparatus according to claim 19, the processor is further configured to:
send first auxiliary information to the first network device, wherein the first auxiliary information is configured to indicate feature information recommended by the user device for a secondary cell to serve as a primary cell.

26. The communication apparatus according to claim 19, the processor is further configured to:
send second auxiliary information to the first network device, wherein the second auxiliary information comprises a channel quality indicator between the user device and the at least one secondary cell.
